(19) United States
(12) Patent Application Publication
(10) Pub. No.: US 2024/0150124 A1
(43) Pub. Date: May 9, 2024

(54) SYSTEM, METHOD AND USE FOR PICKING OBJECTS FOR EYEGLASS MANUFACTURING

(71) Applicant: Schneider GmbH & Co. KG, Fronhausen (DE)

(72) Inventors: Torsten GERRATH, Marburg (DE); Helwig BUCHENAUER, Dautphetal-Buchenau (DE); Gunter SCHNEIDER, Marburg (DE)

(21) Appl. No.: 18/281,186

(22) PCT Filed: Mar. 8, 2022
(86) PCT No.: PCT/EP2022/055854

§ 371 Date: Sep. 8, 2023

(30) Foreign Application Priority Data
Mar. 8, 2021 (DE) 10 2021 001 209.7
Mar. 9, 2021 (DE) 10 2021 001 248.8

(51) Int. Cl. B65G 1/137; B65G 1/04

(52) U.S. Cl. CPC B65G 1/1378; B65G 1/0485

(57) ABSTRACT

A system, method and use for picking objects for eyeglass manufacturing are proposed. The objects are stored in storage containers and output via a collecting conveyor in such a way that objects belonging to a defined work order are deposited adjacent to each other. At a storage outlet, a transport box is loaded with the deposited objects belonging to a defined work order and the loaded transport box is transported out of the system.

### CROSS-REFERENCE TO RELATED APPLICATION

This application is a national stage application under 35 U.S.C. 371 of PCT Application No. PCT/EP2022/055854, having an international filing date of 8 Mar. 2022, which designated the United States, which PCT application claimed the benefit of German Patent Application No. 10 2021 001 209.7, filed 8 Mar. 2021 and German Patent Application No. 10 2021 001 248.8, filed 9 Mar. 2021, each of which are incorporated herein by reference in their entirety.

### BACKGROUND

### Technical Field

The present invention relates to a system for transporting and storing objects, in particular optical objects.

### Description of the Related Art

A generic system or method is known, for example, in the form of systems and their use in pharmacies. Such a system consists of a storage device with storage shelves arranged one above the other and a handling device (e.g. robot arm with gripper or grippers) which can be moved along the storage shelves and which is used to place medications to be stored, packed in cartons, on the storage shelves or, on order (by means of an external computer), to remove the requested medication from the corresponding storage shelves and to transport it to a storage outlet. There, the requested medication is typically transferred to an output chute or to an output conveyor.

However, the generic system is only suitable for dispensing individual ordered medications in the order in which they are requested or ordered.

WO 2011/151275 A1 discloses a picking system, wherein a warehouse management computer can virtually define an area on a central belt on which a picking order is to be picked. The continuously moving central belt is fed past various vending machines that can dispense boxed medications onto the virtual area. At the end of the central conveyor, the picked boxes are placed in a collection bin for this picking order and from there they are made ready for dispatch by the transport system or transported to another picking location.

DE 35 33 382 A1 discloses a computer-controlled picking system, whereby articles fall from inclined storage bins onto a collecting conveyor, where they form loose heaps that drop into boxes at the end of the conveyor.

DE 28 35 404 A1 discloses a system for storing and dispensing objects, in particular medications, wherein individual objects fall loosely onto a central conveyor belt and are conveyed by a transverse belt into a collection container.

DE 20 2016 103 890 U1 discloses an order picking system, wherein objects from storage compartments are first transferred for picking an order.

DE 10 2004 017 579 A1 discloses a picking system for medications, whereby the medications are manually placed in an unordered manner on a collecting conveyor and can slide into various collecting bins via a central sorter.

### SUMMARY

The object of the present invention is to provide a system such that objects of various kinds, in particular objects packaged in any manner, can be stored and dispensed in a controlled manner, enabling in particular optimized picking for the manufacture of eyeglasses.

The task is solved by a system as disclosed herein.

The system according to the proposal is preferably characterized in that in particular each storage unit has at least one collecting conveyor which extends along the storage shelves and opens into the storage outlet, that at least one transport conveyor for transport boxes extends along the storage outlets, that at in particular each storage outlet a handling apparatus is provided which is suitable for loading a transport box with storable or stored objects located on the respective collecting conveyor, in such a way that each transport box finally contains objects to be stored or stored which belong to precisely one defined work order.

The method according to the proposal is preferably characterized by the following method steps: depositing stored objects on at least one collecting conveyor in such a way that objects belonging to a defined work order are deposited adjacent to one another, transporting the objects deposited on the at least one collecting conveyor to the storage outlet, loading a transport box with the deposited objects belonging to a defined work order, transporting the loaded transport box out of the system.

Another aspect of the present invention, which can also be implemented independently, preferably provides that storage containers with objects therein are first assembled for a work order and then the objects for the work order are transferred from the storage containers into a transport box. Then, preferably, the storage containers are returned and loaded or charged with new objects for storage or temporary storage.

According to the proposal, in particular automated and optimized picking of objects for the manufacture of spectacles is made possible. It should be taken into account here that the objects required in each case for the manufacture of a pair of spectacles, in particular lenses or lens blanks, but also a spectacle frame, a tool and/or the like, are deposited in particular in a defined manner or at specific positions in a transport box and/or are removed from storage or delivered in an automated manner by means of a storage container or a transport box, in order to enable simple automated spectacle manufacture.

With the system or method according to the proposal it is possible (in contrast to the generic prior art) to store objects to be stored at arbitrary positions within the storage unit, but to selectively dispense stored objects in such a way that in particular objects belonging together, i.e. objects belonging to the same work order, are deposited on a collecting conveyor together, i.e. essentially next to each other, in such a way that they appear one after the other at the storage outlet so that one and the same transport box can be loaded with them. In other words, the stored objects are not delivered in the order in which they were ordered or requested, but rather in order of the respective work order.

Such work orders are typically manufacturing or assembly orders, where the stored objects belonging to a work order are components for the manufacture or assembly of an intermediate product or final product.

A particularly preferred application or use of the system or method according to the proposal relates to the optical industry, in particular the manufacture of eyeglasses. For this purpose, typically two lens blanks, possibly of different processing stages, an associated spectacle frame and/or one or more block pieces are combined, which belong to the same work order, for example for a particularly individually specified pair of spectacles.

Advantageous further embodiments result from the subclaims.

Preferably, at least three storage devices are provided. The more storage facilities are provided, the more objects can be stored, depending on customer requirements. Furthermore, the redundancy of the system according to the proposal is increased, since, for example, if one storage device fails, the remaining storage devices are still functional. In this context, it is advantageous if the objects to be stored are distributed evenly according to type and kind, in particular among all existing storage facilities, so that each type or kind of object is accessible even if one storage unit fails.

A preferred further embodiment of the present invention is that the at least one collecting conveyor is configured and/or controlled to transport objects to be stored that belong to a defined work order together to the storage outlet.

In a particularly preferred manner, the at least one collecting conveyor is controlled in a clocked manner. This further development allows the throughput of the output of stored objects to be adapted in particular to individual customer requirements. Furthermore, the common storage of objects belonging to a work order on the collecting conveyor is simplified.

A further, particularly preferred embodiment of the present invention is characterized by the fact that at least two, preferably three transport tracks are provided for transport boxes. This makes overtaking operations possible, so that transport boxes can be transported independently of one another to a storage outlet of any storage unit.

Preferably, the at least two transport tracks are designed in such a way that transport boxes can be moved between the at least two transport tracks. This increases the flexibility of transporting the transport boxes to the various storage outlets.

It is expedient that at least one transport track is designed in such a way that loaded transport boxes are transported out of the system, i.e. that in particular fully loaded transport boxes are collected on this transport track and in particular are discharged from the system one after the other.

Preferably, at least some of the objects to be stored are accommodated in storage containers. The storage containers are preferably used to hold objects, in particular objects that are not packed in cardboard boxes, i.e. cannot be transported into the storage systems and placed on storage shelves as in the case of the medication storage described at the beginning. The use of storage containers has the advantage that the handling devices provided in the storage systems can handle the storage containers without requiring modification.

More expediently, the storage containers are provided with a readable storage medium, preferably an RFID chip, to individualize them.

Furthermore, at least one reading device is preferably provided which is suitable for reading the readable storage medium and/or an identification, such as a barcode, located on the storable object or its packaging. In this way, the storage container and the object accommodated therein can be associated or “paired” with each other.

The term “paired” is preferably understood here to mean that the readable storage medium of a storage container and/or a transport box (see below) and the data stored on the identification of an object or its packaging, in particular in the form of data, are linked to one another.

The linked data can be stored in a database and/or on the readable storage medium. This makes it possible, in particular, that when the objects or storage containers and/or transport boxes are transported by the system according to the proposal, only the storage medium of the storage container or transport box needs to be read out in order to obtain, in particular, the data of the object.

The system according to the proposal thus receives or has the information in which storage container which object is stored or on which shelf location this storage container is stored.

When an object received in a storage container is ordered or retrieved, this storage container with the ordered or retrieved object received therein is placed on the at least one collecting conveyor.

After the transport boxes have been loaded with objects, empty storage containers remain. These can advantageously be returned to a packing station or to a storage container by means of a return conveyor in order to be reloaded or stored there.

Individual ones of the foregoing and subsequent aspects and features of the present invention may be combined with each other in any desired manner, but may also be implemented independently of each other.

Further aspects, features, advantages and characteristics of the present invention will be apparent from the claims and the following description of a preferred embodiment with reference to the drawings.

### BRIEF DESCRIPTION OF THE DRAWINGS

It show in schematic, not to scale:

FIG. 1 a schematic top view of a system according to the proposal;

FIG. 2 the system in a first perspective view;

FIG. 3 the system in a second perspective view;

FIG. 4 the system with schematic representation of collecting conveyors;

FIG. 5 a schematic detailed view of a collecting conveyor with a first cycle;

FIG. 6 a schematic detailed view of a collecting conveyor with a second cycle;

FIG. 7 a schematic detailed view of the storage outlets with collecting conveyors, transport tracks and return conveyors.

### DETAILED DESCRIPTION

In the figures, the same reference signs are used for the same components and parts, even if a repeated description is omitted.

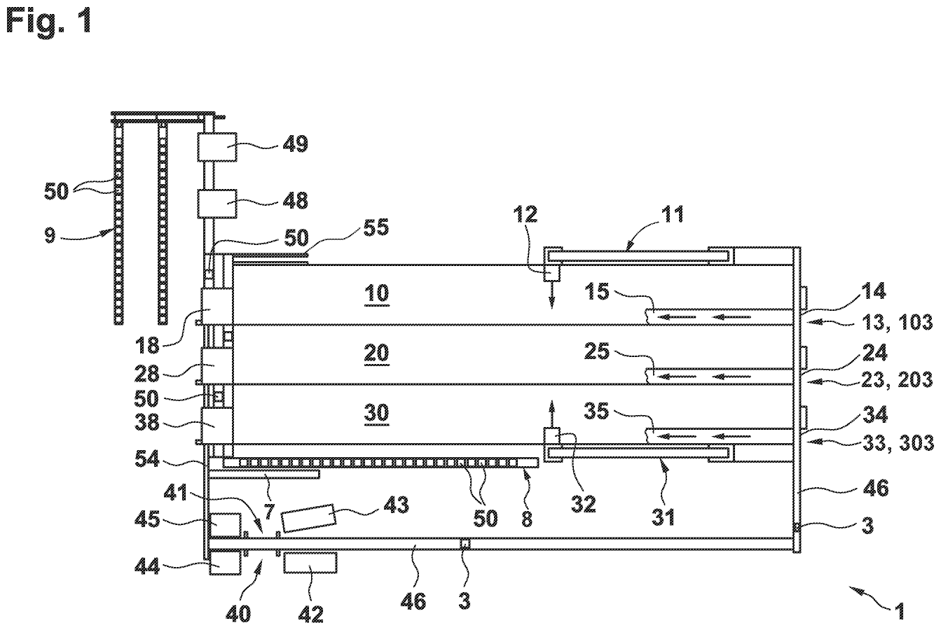

FIGS. 1 to 3 show an embodiment example of a system 1 according to the proposal for picking or for transporting, storing and/or dispensing objects 2.

The objects 2 in the sense of the present invention are preferably objects of the optical industry, in particular for the manufacture of eyeglasses, for example, in particular ophthalmic, lenses or lens blanks, eyeglass frames, block pieces and/or consumables or tools, in particular for processing ophthalmic lenses. Optionally, however, it may also be contact lenses or objects for the manufacture of contact lenses.

Preferably, several objects 2 are required in each case for manufacturing orders (work orders) in the optical industry. Typically, two lens blanks or finished lenses, a spectacle frame and/or one or more block pieces are combined for the manufacture of spectacles, in particular belonging to one work order.

A “work order” in the sense of the present invention is preferably understood to mean a manufacturing order in the optical industry, in particular an order for the manufacture of eyeglasses. Optionally, however, it may also be an order for the manufacture of contact lenses or pairs of contact lenses.

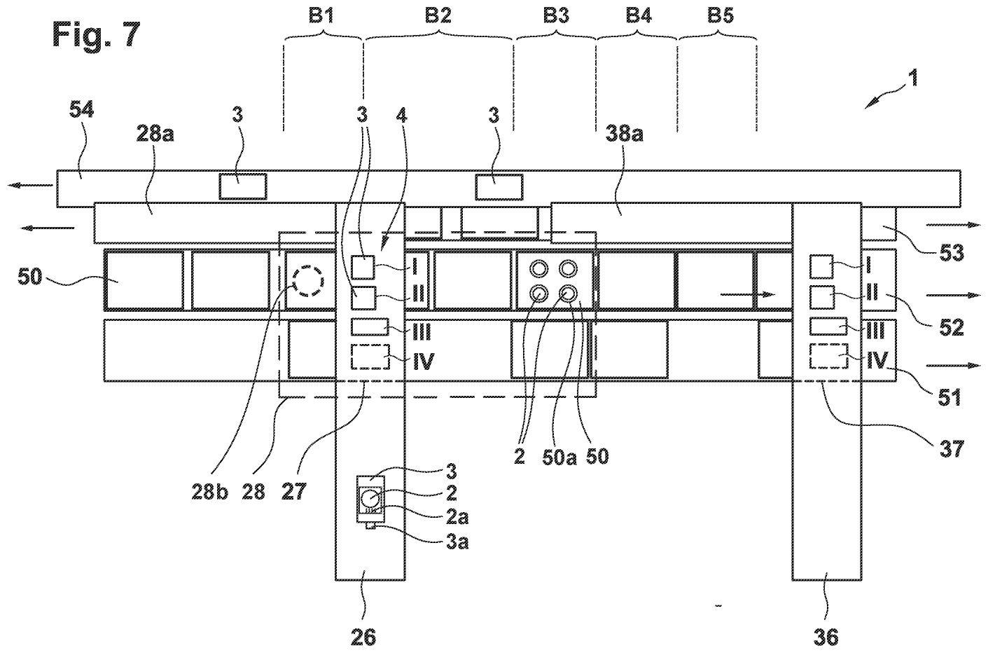

According to the proposal, a work order 4 comprises one or more objects 2 in the sense of the present invention, in particular several or all objects 2 which are required for the manufacture of an optical object or product, such as spectacles or other optical aids. In FIG. 7, several objects 2 of a work order 4 are shown as an example, whereby in the example shown, four objects 2 of the work order 4 are located at storage position I, II, III, IV and in particular (still) in storage containers 3.

The objects 2 may be unpackaged or, in particular, packaged in any way, for example in cardboard boxes, bags, in particular made of plastic, and/or other containers known per se, as schematically indicated in FIG. 7 on a collecting conveyor 26 below for an object 2 located in a storage container 3.

The object 2 may in principle also be packaged and/or provided itself or on its packaging with an identification 2a, such as a barcode, a number or the like, as indicated below in FIG. 7.

The objects 2, especially per work order, may be different and/or similar objects.

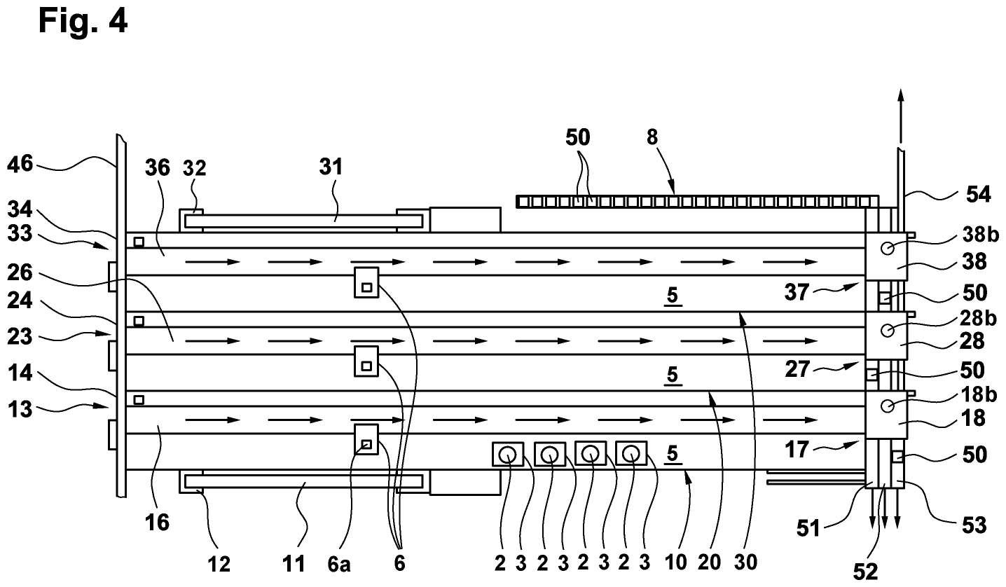

The system 1 preferably has several, in the example shown in particular three, storage units 10, 20, 30 for receiving or storing the objects 2, as indicated in FIGS. 1 to 3, each of which has a storage shelf 5, as indicated schematically in FIG. 4.

In a preferred embodiment of the system 1 according to the proposal, the storage units 10 and 30 serve for storing all conceivable types of objects 2 to be stored or stored, such as spectacle frames, lens blanks, lenses of different processing stages and consumables, respectively, while the storage unit 20 preferably serves for storing objects 2 accommodated in storage containers 3, such as spectacle frames packed in bags.

Preferably, the system 1 has loading devices 11, 31.

The loading devices 11, 31 are preferably used for loading the storage units 10 or 30 with objects 2 which—similar to medications or other pharmaceutical products—are packed in particular individually in cardboard boxes, such as lens blanks.

In the illustrated example, the loading device 11, 31 has a container with, in particular, a conveyor, a separating device and a conveyor belt 12, 32.

The container serves to receive the in particular packaged objects 2, which are to be stored or received in the storage units 10, 30, in an unsorted manner, whereby the in particular integrated conveyor automatically transports the objects 2 to be stored in the direction of the separating device or in the direction of a storage inlet. By means of the separating device, the in particular unsorted objects 2 are separated and conveyed or guided individually via a conveyor belt 12, 32 into the storage unit 10, 30. From there, the objects 2 to be stored are picked up individually in an automated manner or by a handling device (not shown) and deposited in a storage location in a storage shelf 5 of the respective storage unit 10, 30.

Preferably, the loading devices 11, 31 are located on the longitudinal sides of the storage devices 10, 30. Particularly preferably, the loading devices 11, 31 are arranged in such a way that they are accessible to an operator.

The loading devices 11, 31 are preferably used for automated and, in particular, orderly loading of the storage units 10, 30.

Filling or loading of the container or conveyor of the loading devices 11, 31 is preferably performed manually, in particular by an operator.

In a preferred embodiment, the objects 2 to be stored, which are to be stored via the loading devices 11, 31, are initially present in bundles with several objects 2, in this case in particular lens blanks, individually packed in cardboard boxes. The objects 2 packed in cardboard boxes are freed, if necessary, from an outer packaging belonging to the bundle, in order to be subsequently given, in particular in a disordered manner, especially preferably poured, onto the conveyor belt of the loading device 11, 31. This is preferably done manually or by an operator.

After the loading device 11, 31 has been filled, preferably manually, with objects 2 to be stored, the transport of the objects 2 by means of the conveyor to the separating device, the separation of the objects 2 and/or the storage by means of the conveyor belt 12, 32 are carried out, preferably automatically.

Furthermore, the loading device 11, 31 serves in particular to place and/or store the objects 2 to be stored individually and/or in an orderly manner and/or in a defined position on the conveyor belt 12, 32.

Furthermore, the system 1 preferably has one or more storage devices 13, 23, 33, which are assigned in particular to the storage units 10, 20, 30. In the example shown, the storage units 10, 20, 30 each have one or more storage devices 13, 23, 33, in particular on one of their end faces.

The storage devices 13, 23, 33 serve in particular to store objects 2 accommodated in storage containers 3 or to transport them to the storage units 10, 20, 30, in particular via corresponding storage inlets 103, 203, 303.

The storage containers 3 are preferably boxes, which in particular can have different dimencions or sizes. Alternatively, storage containers 3 of only one size can also be used here. The storage containers 3 are preferably made of plastic, but can also be made of any other material.

In particular, the storage containers 3 are used to hold at least some or all of the objects 2 to be stored, preferably individually.

The storage containers 3 can hold unpackaged objects 2 and objects packaged as desired, particularly preferably in bags and/or pouches.

Preferably, the storage containers 3 have a particularly integrated storage medium 3a, especially preferably an RFID chip, in particular for their individualization, i.e. each storage container 3 preferably has its own or individual identifier, such as a combination of digits and/or letters.

Preferably, the system 1 comprises one or more packing stations 40, 41.

In the example shown, the packing stations 40, 41 are arranged on one or more conveyor belts 46 of the system 1. Alternatively or additionally, however, the packing stations 40, 41 can also be removed from the system 1 or separated from it.

Preferably, objects 2, in particular in any packaging units 42, 43, and/or preferably in storage containers 44, 45, are delivered or provided at the packing stations 40, 41.

In the example shown, the packing stations 40, 41 are used in particular to transfer the delivered objects 2, in particular individually, into a storage container 3. Here, for example, a spectacle frame can be transferred to a larger storage container 3 and a “finished lens”, i.e. in particular a finished lens, to a smaller storage container 3.

The transfer of an object 2 into a storage container 3 can be carried out manually, in particular by an operator, as indicated in FIGS. 1 to 3. Alternatively or additionally, however, this can also be done automatically or, in particular, an automated unpacking system can be provided.

After a storage container 3 has been loaded with an object 2 to be stored, the aforementioned storage container 3 is placed in storage and, for this purpose, is first preferably deposited on a conveyor belt 46.

Preferably, the system 1 has a conveyor belt 46, more preferably several, in particular two, conveyor belts 46. These are used in particular for transporting the storage containers 3, in particular those loaded with objects 2, to the storage inlets 103, 203, 303 or to the storage devices 13, 23, 33.

For transporting different storage containers 3 or storage containers 3 with different dimensions or sizes, the conveyor belts 46 can have different dimensions or widths, depending on the dimensions or width of the storage containers 3.

The storage containers 3 loaded with objects 2 are preferably first guided on one or more conveyor belts 46 to a reading device (not shown). The reading device is used in particular to read the data stored on the storage medium 3a or RFID chip of the storage containers 3 and/or the data stored, for example in the form of a barcode or other identification 2a, on the packaging of the objects 2 accommodated in a storage container 3 or on the packaging itself.

In the embodiment example, these data are combined or “paired” with each other in such a way that in the system 1 according to the proposal, or also alternatively on the storage medium 3a of the storage container 3, it is stored which object 2 is accommodated in which storage container 3.

In the example shown, the storage containers 3, in particular those loaded with objects 2, are then transported to the storage devices 13, 23, 33, in particular by means of or on the conveyor belt 46.

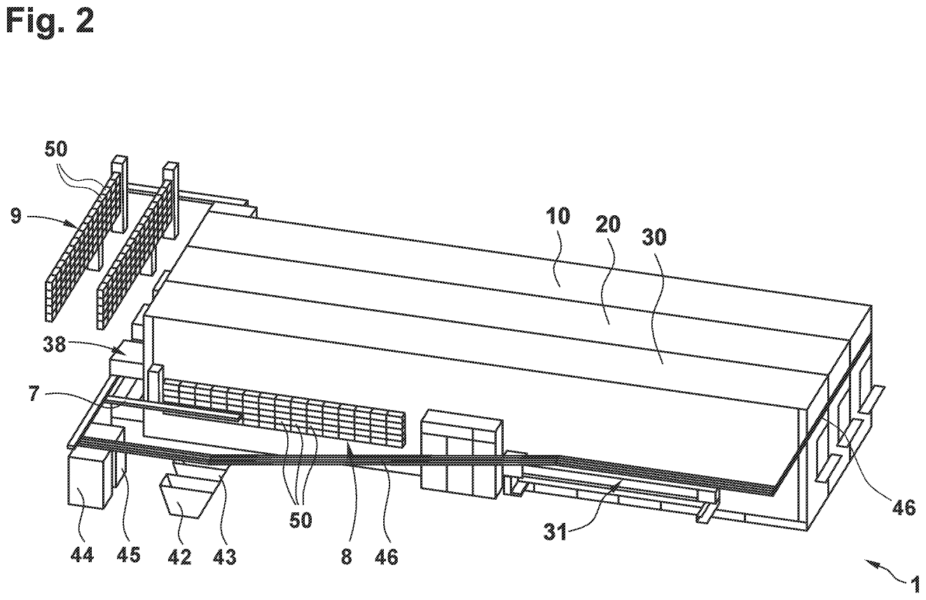

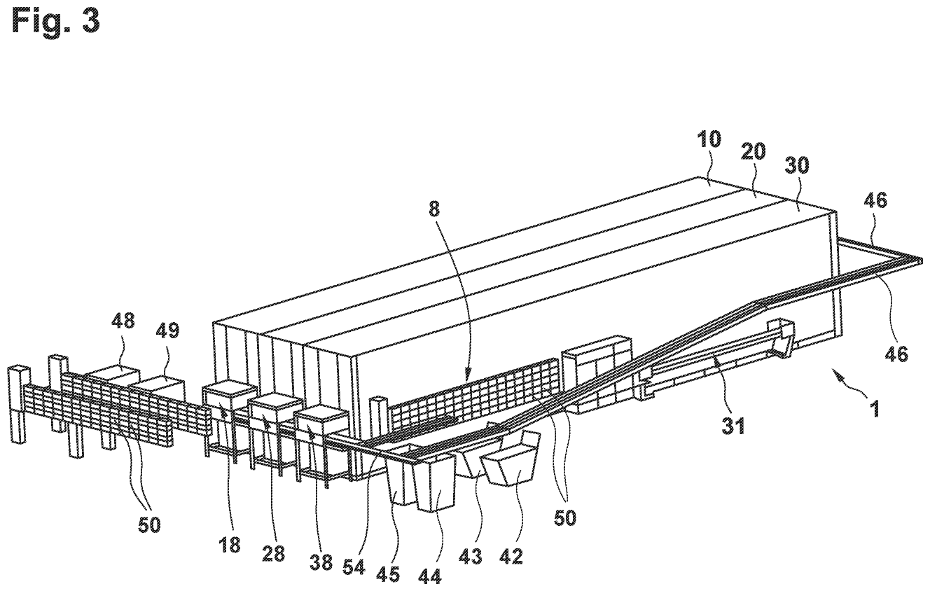

In a preferred embodiment, the conveyor belts 46 run along the storage device 10 or extend along its longitudinal side (see FIGS. 2 and 3). Particularly preferably, the conveyor belts 46 are arranged parallel to each other.

Furthermore, the conveyor belts 46 are preferably designed as a ramp or extend obliquely upwards, in particular along the storage device 10, in particular in the direction of the storage devices 13, 23, 33. In this way, the storage containers 3 are transported to the storage devices 13, 23, 33.

The storage devices 13, 23, 33 are preferably arranged in a different or higher plane than the loading devices 11, 31.

The storage devices 13, 23, 33 serve in particular to store objects 2 accommodated in storage containers 3 or to transport them to the storage units 10, 20, 30.

Preferably, the storage device 13, 23, 33 has a transfer device, for example a gripping device and/or a pusher. This is preferably used to transport or grip and/or push the storage containers 3, in particular from the conveyor belt 46, onto a storage conveyor 15, 25, 35.

In a preferred embodiment, the transfer device is a gripping device that takes or grips the storage container 3 to be stored from the conveyor belt 46, lifts the storage container 3 and then places it on a storage conveyor 15, 25, 35.

The storage conveyors 15, 25, 35 preferably serve to transport the storage containers 3, in particular those loaded with objects 2, into the interior of the storage units 10, 20, 30. There, the storage containers 3 are picked up automatically or by a handling device (not shown) and deposited in a storage shelf 5, in particular in a storage location of a storage shelf 5.

Preferably, the system 1 has, in particular at or in the area of the storage devices 13, 23, 33, one or more reading devices 14, 24, 34, in particular for readable storage elements, such as RFID chips and/or barcodes, for example.

The reading devices 14, 24, 34 are preferably used to read the storage medium 3a or the RFID chip of the storage container 3. This primarily serves the purpose of detecting or tracking the storage containers 3 delivered via the conveyor belt 46 or via the ramp and loaded with objects 2 to be stored and/or assigning the storage container 3 to be stored to a storage unit 10, 20, 30 or deciding in which storage unit 10, 20, 30 the storage container 3 is to be transported or stored.

The system 1 according to the proposal therefore now knows in which storage container 3 which object 2 is accommodated (higher-level software) or in which storage unit 10, 20, 30 or in which storage shelf 5 and/or storage location a storage container 3 or an object 2 defined, for example, by means of a barcode is stored (storage software).

Optionally, the system 1 additionally has a conveyor, in particular a chute, which is preferably used to transport away or eject storage containers 3 that are not to be transported to or stored in one of the storage units 10, 20, 30. For example, a storage medium that cannot be read out, such as an RFID chip that is faulty or contains faulty data, can mean that a storage container 3 that is equipped with an object 2 and has been transported via a conveyor belt 46 to a storage device 13, 23, 33 is not to be stored after all. In this case, the corresponding storage container 3 can be transported past the storage inlets 103, 203, 303 or storage devices 13, 23, 33 in the direction of the conveyor belt and transported away via the conveyor or discharged from the system 1.

FIG. 4 shows an enlarged section of the system 1 according to FIGS. 1 to 3, focusing in particular on picking the stored objects 2.

The storage units 10, 20, 30, particularly preferably each storage unit 10, 20, 30, preferably have a collecting conveyor 16, 26, 36, wherein the collecting conveyor 16, 26, 36 preferably extends along the storage shelves 5 and in particular opens into a respective storage outlet 17, 27, 37.

In the example shown, the collecting conveyors 16, 26, 36 preferably extend over the entire length of the storage equipment 10, 20, 30 or storage shelves 5. However, the collecting conveyors 16, 26, 36 can also be shorter, for example only half as long, or extend only over a section or not over the entire length of the storage equipment 10, 20, 30.

The collecting conveyors 16, 26, 36 serve in particular to pick up objects 2 stored in the storage units 10, 20, 30 or storage containers 3 loaded with objects 2, preferably in work order, and to transport them to the storage outlet 17, 27, 37. The transport can be continuous and/or clocked.

Optionally, the collecting conveyors 16, 26, 36 can also be formed by the storage conveyors 15, 25, 35 or vice versa.

Optionally, the loading devices 11, 31 and conveyor belts 12, 32 or their function can also be realized by the storage devices 13, 23, 33.

Optionally, the storage devices 13, 23, 33 comprise the storage conveyors 15, 25, 35, and/or the reading devices 14, 24, 34.

Preferably, the storage units 10, 20, 30, loading devices 11, 31 and/or storage devices 13, 23, 33 have one or more handling devices 6 (schematically indicated in FIG. 4) for storing objects 2 (with or without storage containers 3) in one or more storage shelves 5 and/or for retrieving them from one or more storage shelves 5.

Optionally, the handling devices 6 may also comprise the reading devices 14, 24, 34.

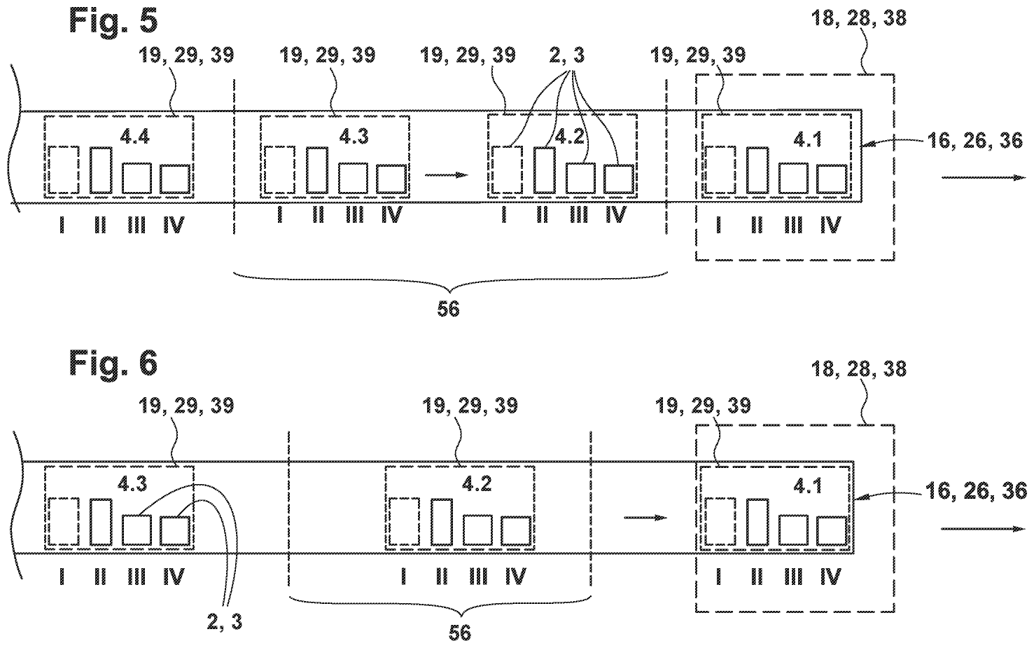

FIGS. 5 and 6 show partial views of collecting conveyors 16, 26, 36 with different control and timing, respectively.

In the illustration example, it is assumed that a work order 4 comprises up to four, i.e. one to four objects 2. For example, a work order 4 can consist of two lenses or lens blanks as well as two block pieces or of two lenses or lens blanks as well as a spectacle frame.

Further, the collecting conveyor 16, 26, 36 preferably has at least one depositing location 19, 29, 39 (identified by the dashed outline) on which the objects 2 or the storage containers 3 loaded with objects 2 from the storage shelf 5 of the corresponding storage unit 10, 20, 30 belonging to a work order 4 are (are to be) deposited.

Accordingly, the depositing location 19, 29, 39 or the collecting conveyor 16, 26, 36 preferably has four storage position I, II, III, IV per work order 4.

Accordingly, up to four objects 2 or storage containers 3 loaded with objects 2 belonging to the same work order 4 can be deposited on the collecting conveyor 16, 26, 36 or on the defined depositing location 19, 29, 39, in particular next to each other, at the storage position I, II, III and/or IV. Not all positions have to be occupied. For example, a lens blank can be deposited in each of the storage positions I, II and a spectacle frame in location III, while location IV remains free.

The depositing of the objects 2 or storage containers 3 belonging to a work order 4 on the depositing location 19, 29, 39 of the respective collecting conveyor 16, 26, 36 is preferably carried out in a defined manner (i.e. in particular at the defined storage positions I to IV within the respective depositing location 19, 29, 39 or generally within a specific depositing location 19, 29, 39) or in an ordered manner, individually and/or next to each other.

Preferably, depositing onto the collecting conveyor 16, 26, 36 takes place at only one depositing location 19, 29, 39 at a time (in FIGS. 5 and 6, in particular the one on the far left).

A handling device 6, which is schematically indicated in FIG. 4 and optionally also serves to store objects 2 with and/or without storage containers 3 in the storage shelf 5, picks up or grips (preferably by means of a manipulator 6a, which is only schematically indicated), in particular one after the other and/or individually, a counter object 2 or storage container 3 from its respective depositing location or from the respective storage shelf 5 and deposits it in a defined manner or at a defined storage position I, II, Ill, IV on the depositing location 19, 29, 39 or the collecting conveyor 16, 26, 36. In this way, objects 2 or storage containers 3 belonging to a work order 4 are assembled or picked with the corresponding objects 2, in particular in an orderly manner.

The objects 2 or storage containers 3 belonging to a work order 4 deposited at the depositing location 19, 29, 39 are then transported or conveyed to the storage outlet 17, 27, 37 on the collecting conveyor 16, 26, 36. This can take place in different variants.

In a first variant of the method according to the proposal, the collecting conveyor 16, 26, 36 is moved slowly but continuously in the direction of the arrow (in the direction of the respective storage outlets 17, 27, 37). Preferably, the speed is low enough that the handling device 6 can pick up all objects 2 belonging to the same work order 4 or their storage containers 3 from their respective storage location and deposit them on the respective positions I, II, III, IV on the collecting conveyor 16, 26, 36.

In a second, preferred variant of the method according to the proposal, the collecting conveyor 16, 26, 36 is controlled in a clocked manner. In particular, the collecting conveyor 16, 26, 36 is stationary as long as or while the storage positions I, II, III and/or IV are occupied by objects 2 or their storage containers 3. Then the collecting conveyor 16, 26, 36 is moved a certain preselected distance in the direction of the arrow (in the direction of the respective storage outlets 17, 27, 37) and subsequently stopped again. Now new storage positions I, II, III, IV located upstream are filled with objects 2 belonging to the same work order 4.

This second, preferred variant of the method according to the proposal has the advantage that, as shown in FIGS. 5 and 6, each collecting conveyor 16, 26, 36 can be individually timed, in particular according to customer requirements.

The illustration example according to FIG. 5 shows, in comparison with FIG. 6, a comparatively shorter cycle, preferably with the work orders 4.1, 4.2, 4.3 and 4.4 shown as example, in particular with their respective storage positions I, II, III, IV, being defined or arranged at a smaller distance from one another on the collecting conveyor 16, 26, 36. A buffer zone 56 is formed between the left-hand depositing location 19, 29, 39, which is currently occupied, for example, by the objects 2 or storage containers 3—here of order 4.4—by the handling device 6, and the position during reloading—here the right-hand depositing location 19, 29, 39 or order 4.1—which here in particular comprises two or more depositing locations 19, 29, 39 or orders 4.2 and 4.3.

The illustration example according to FIG. 6 shows a comparatively longer cycle, preferably with the work orders 4.1, 4.2 and 4.3, in particular with their respective positions I, II, III, IV, being defined at a greater distance from one another on the collecting conveyor 16, 26, 36. Here, for example, the buffer zone 56 comprises only one depositing location 19, 29, 39 or job 4.2.

FIG. 7 shows a detailed view of the respective storage outlets 17 (not shown), 27, 37 and illustrates the method of transferring or reloading the objects 2 delivered by means of the collecting conveyors 16, 26, 36 into transport boxes 50.

The system 1 has transport boxes 50, which are used in particular for receiving and transporting objects 2 that have been stored and/or picked or assembled by work order.

The transport boxes 50 preferably have several or defined receiving locations 50a and preferably at least so much space or at least so many receiving locations 50a that all objects 2 of a work order 4 can be transported in a common transport box 50. Particularly preferably, the number of available receiving locations 50a per transport box 50 corresponds to the number of storage position I, II, Ill, IV per depositing location 19, 29, 39 on the collecting conveyor 16, 26, 36. In other words, one transport box 50 preferably corresponds to one work order 4.

Preferably, the system 1 has a plurality of transport tracks 51, 52, 53.

The transport tracks 51, 52, 53 preferably serve to transport the transport boxes 50, in particular along the storage outlets 17, 27, 37.

The transport tracks 51, 52, 53 are preferably arranged parallel to each other and/or, in particular, have the same running direction along or in relation to the storage outlets 17, 27, 37.

In the example shown, the transport tracks 51, 52, 53 are designed as separate transport belts. However, the transport tracks 51, 52, 53 can also be designed as a single (wide) transport belt or in the form of two transport belts, for example in the form of a narrow and a wide transport belt. However, other design solutions are also possible.

Preferably, the transport tracks 51, 52, 53 or conveyor belts are driven by a common motor. However, several motors can be provided instead of one motor. In particular, this allows the conveyor belts to be operated at different speeds.

The system 1 preferably has a (third) transport track 53, which is primarily used to transport or eject fully loaded, in particular completely loaded, transport boxes 50 out of the proposed system 1. However, the transport track 53 can also serve as an overtaking track for transport boxes 50, in particular partially loaded transport boxes 50, and/or for ejecting incorrectly loaded transport boxes 50.

Furthermore, the system 1 preferably has a (second) transport track 52 on which, in particular, empty and/or partially loaded transport boxes 50 are loaded with objects 2 or on which, preferably, the objects 2 belonging to a work order 4 are assembled or picked in the respective transport box 50.

In addition, in a preferred embodiment, the system 1 preferably has a (first) transport track 51, which is preferably used to insert empty transport boxes 50 in particular.

In the example shown, three transport tracks 51, 52, 53 are provided, which run from left to right in the direction of the arrow in FIG. 7.

By “fully loaded” transport boxes 50 in the sense of the present invention it is to be understood, in particular, that the transport boxes 50 are equipped or loaded with all objects 2 belonging to a work order 4. In particular, a transport box 50 may also be fully loaded even if not all receiving locations 50a available in the transport box 50 are occupied, depending on how many objects 2 belong to a work order 4.

“Partially loaded” in the sense of the present invention means in particular that the transport box 50 is not (yet) equipped or loaded with all objects 2 belonging to a work order. For example, a work order 4 may also comprise objects 2 stored in different storage units 10, 20, 30. Then, in an exemplary scenario, a transport box 50 is first loaded with objects 2 from the storage unit 10, transported further in the partially loaded state on the transport track 52 or 53 to the storage unit 30 and loaded there with the remaining objects 2 belonging to the same work order 4.

As can be seen in FIGS. 4 and 7, the system 1 preferably has a handling apparatus 18, 28, 38 at the storage outlets 17, 27, 37, particularly preferably at each storage outlet 17, 27, 37.

Preferably, the handling apparatuses 18, 28, 38 are used for loading transport boxes 50 with objects 2 and/or for transferring, in particular pushing, the transport boxes 50 from one transport track 51, 52, 53 to the other.

The handling apparatus 18, 28, 38 serves in particular to pick up or grip objects 2 located on or delivered by the collecting conveyors 16, 26, 36 directly and/or from the associated storage containers 3 and in particular to transfer them to transport boxes 50 in a work order. Expediently, the handling apparatus 18, 28, 38 particularly preferably comprises a manipulator (in FIG. 7 the manipulator 28b of the handling device 28 is indicated by way of example) or one or more gripping devices known per se for loading the transport boxes 50. In a particularly preferred embodiment, the manipulator 18b, 28b, 38b is designed as a suction device or comprises one or more suction devices.

The picking up or gripping of the objects 2 from the collecting conveyor 16, 26, 36 or from the storage containers 3 by the handling apparatus 18, 28, 38 or its manipulator 18b, 28b, 38b is preferably performed individually. This in turn allows a defined or ordered depositing of the objects 2 into the respective transport box 50, in particular with the desired positioning and/or orientation or on the respective receiving location 50a.

Further, the handling apparatus 18, 28, 38 or the system 1 optionally comprises at least one transfer unit for transferring the transport boxes 50 between the transport tracks 51, 52, 53.

The transfer unit is preferably designed as a pusher or can comprise one or more pushers.

In a particularly preferred embodiment, the transfer unit comprises several, in particular two, pushers, preferably in the form of forks, which move the transport boxes, in particular transversely to the conveying direction of the transport tracks 51, 52, 53. For example, one pusher can serve or be designed to push empty transport boxes 50 from the first transport track 51 to the second transport track 52, while another pusher serves to push transport boxes 50 loaded with objects 2 from the second transport track 52 to the third transport track 53.

Optionally, the handling device 18, 28, 38 or the system 1 or the transfer unit additionally has a pusher, which is used in particular to push partially loaded transport boxes 50 from the transport track 53, which is designed in particular as a passing track, or the third transport track, onto the transport track 52.

Further, the system 1 or the handling apparatus 18, 28, 38 preferably comprises one or more transfer units or pushers, particularly preferably in the form of punches, for discharging in particular empty storage containers 3, particularly onto a return conveyor 54.

Furthermore, the system 1 preferably has the return conveyor 54. This serves in particular to discharge or return empty storage containers 3, especially preferably to the storage containers 44, 45 and/or the packing stations 40, 41.

Preferably, the return conveyor 54 is arranged above the transport tracks 51, 52, 53 or at the level of the collecting conveyors 16, 26, 36.

The conveying direction of the return conveyor 54 is preferably opposite to the conveying direction of the transport tracks 51, 52, 53. However, other design solutions are also possible here.

In a preferred embodiment, the system 1 optionally additionally has conveyor sections 18a (not shown), 28a, 38a, which serve in particular for intermediate storage of empty storage containers 3. These sections can be arranged or run parallel to the return conveyor 54, as shown in FIG. 7, but alternatively also transversely to the return conveyor 54 or parallel and/or adjacent to the collecting conveyor 16, 26, 36.

After loading a transport box 50 with objects 2 by the handling device 18, 28, 38, the empty storage container 3 is preferably transferred or pushed onto the conveyor section 18a, 28a, 38a by the handling apparatus 18, 28, 38 or the transfer unit. From there, the empty storage container 3 can be transferred or pushed onto the return conveyor 54.

Alternatively or additionally or in principle, the empty storage container 3 can also be conveyed or pushed directly from the collecting conveyor 16, 26, 36 onto the return conveyor 54.

However, if the return conveyor 54, in particular in the area of the handling apparatus 18, 28, 38, should already be occupied by a storage container 3, the empty storage container 3 in question can be transferred or pushed from the collecting conveyor 16, 26, 36 onto a conveyor section 18a, 28a, 38a, in particular by means of the handling apparatus 18, 28, 38, in such a way that the empty storage container 3 can run along on the respective conveyor section 18a, 28a, 38a preferably parallel to the return conveyor 54. Preferably, the empty storage container 3 can then be pushed to a free place on the return conveyor 54 by means of a pusher known per se.

The return conveyor 54 transports the empty storage containers 3 away, in particular to the packing stations 40, 41 and/or storage containers 44, 45, and preferably makes them available for loading with new objects 2 or objects to be stored and/or picked.

The handling apparatuses 18, 28, 38 preferably each have a manipulator 18b, 28b, 38b (in FIG. 7, for reasons of simplification, only the handling apparatus 28 with its manipulator 28b is shown very schematically) for picking up, in particular gripping, an object 2, preferably one at a time, in order to deposit or reload it in a desired transport box 50 and, in particular, to position the object 2 in the desired receiving location 50a in the transport box, i.e. to deposit it in a defined manner.

The handling apparatuses 18, 28, 38 and/or their manipulator 18b, 28b, 38b are preferably arranged above the collecting conveyors 16, 26, 36 and/or transport tracks 51, 52, 53 and/or movable along and in particular also transversely to the conveying direction of the transport boxes 50 and/or to the transport tracks 51, 52, 53, in order to be able to pick up the objects 2 in their respective positions I to IV and deposit them, as desired, at a receiving location 50a of the transport box 50.

The handling apparatus 18, 28, 38 or the transport tracks 51, 52, 53 are preferably assigned different areas B for the transport boxes 50. This is explained in more detail below by way of example with reference to FIG. 7, in particular with regard to the handling apparatus 28. In FIG. 7, the handling apparatus 28 is only indicated by dashed lines and the other handling apparatuses 18, 38 are omitted for better clarity, even if the same applies in this respect.

The system 1 or the handling device 28 preferably has an area B1 in which an empty transport box 50 can be pushed from the first transport track 51 to the second transport track 52 by means of the transfer unit or a pusher. B1 is preferably upstream and/or upstream of and/or below the respective handling apparatus 28 or the respective collecting conveyor 26 or storage outlet 27.

Furthermore, an area B2 is preferably provided which functions in particular as a waiting area for preferably empty or partially loaded transport boxes 50 before (further) loading with objects 2. B2 preferably adjoins B1 and/or refers in particular to the second transport track 52 and/or preferably extends under the respective collecting conveyor 26 and/or beyond this or the respective storage outlet 27 in the conveying direction.

In addition, the system 1 or the handling device 28 preferably has an area B3 in which the loading of the transport boxes 50 with objects 2 takes place, in particular by means of the respective manipulator 28b of the respective handling device 28. B3 preferably adjoins B2 and/or refers in particular to the second transport track 52.

A further optional area B4 preferably adjoins B3 and/or preferably serves as a waiting area for fully and/or partially loaded transport boxes 50.

Furthermore, the system 1 or the respective handling device 28 preferably has an area B5 in which the transfer of fully and/or partially loaded transport boxes 50 to the third transport track 53 for discharge from the system 1 can take place.

At or before the storage outlets 17, 27, 37 or in the areas B1, a certain number of empty transport boxes 50 is preferably pushed or transferred in each case, in particular from the first transport track 51 to the second transport track 52 and held there, preferably in the area B2 or in the waiting area.

Since three transport tracks 51, 52, 53 are provided in the embodiment example, there are, according to the proposal, several scenarios or sequences for loading the transport boxes 50.

In a first, preferred scenario or sequence, a transport box 50 is transported on the transport track 52 from the area B2 or the waiting area to a storage outlet 17, 27, 37 and/or into the area B3 and is loaded there, in particular, completely or with all the requested objects 2 belonging to one and the same work process. Subsequently, the transport box 50 is transported on the transport track 52 to a further waiting area or the area B4 and then or in the area B5 is pushed or transferred by means of the transfer unit or a pusher of the handling apparatus 18, 28, 38 to a free place on the transport track 53 and is discharged from the system 1 via the transport track 53.

In a second scenario or sequence, a transport box 50 is loaded at several storage outlets 17, 27 or 27, 37 or 17, 27, 37, i.e. it requires two or three different and/or successive or also spaced storage outlets in order to be loaded completely or with all objects 2 belonging to a work order 4. In this case, a partially loaded or not fully loaded transport box 50 is preferably transported on the second or middle transport track 52 to the immediately following storage outlet 27, 37 and loaded there as described above. Finally, the fully loaded transport box 50 is pushed or transferred onto the conveyor belt 53, as already described, in particular in the corresponding area B5, and is transported out of the system 1 according to the proposal or discharged.

In a third scenario or sequence, a transport box 50 is loaded at or before several storage outlets 17, 37, with at least one storage outlet 27 in between or skipped. In this case, the incompletely loaded transport box 50 from the storage outlet 17 is pushed or transferred to the first transport track 51 or the third transport track 53 and transported by the latter to the area B1 of the handling apparatus 38 or to in front of the storage outlet 37, where it is pushed again to the middle transport track 52 or transport track 52 serving for loading. The transport box 50 is then completely loaded and discharged from the system 1 as described.

In a fourth scenario or sequence, two lens blanks are to be combined with a so-called “customer frame”, i.e. an individual spectacle frame sent by an optician, for example. Theoretically, the lens blanks could be finished with the exception of the edging and stored until the spectacle frame is available. However, it is preferred not to start manufacturing the spectacles until the spectacle frame is available. This is then manually placed in a transport box 50, for example, and the transport box 50 is treated as an incompletely loaded transport box 50, as described above for the second and third scenarios. After the automated complete loading, in particular with the lens blanks, this transport box 50 can also be discharged or delivered as described.

As shown in FIGS. 1 and 2, the transport boxes 50, particularly as they are transported out of the system 1, may optionally still pass through a reader 48 and/or a printer 49.

The reader 48 preferably serves to read a storage medium, such as an RFID chip, integrated in particular in the transport box 50, in particular in such a way that the work order recorded or associated therein is identified.

The printer 49 is used in particular for printing a so-called “job ticket” or a ticket which serves for the identification of a work order. In a preferred embodiment, the printer 49 is a combination device, preferably comprising a printer, a folding machine and/or a handle, which in particular prints out a “job ticket” with the details of the respective work order, folds it and/or inserts it into the transport box 50.

Optionally, the reader 48 and printer 49 may be integrated or combined into a single device.

Further, there may also be two or more printers 49 and/or reader 48, particularly to improve redundancy.

As shown in FIG. 1, the system 1 preferably has a waiting or discharge conveyor 55. This serves to eject, in particular, faulty or incorrectly loaded transport boxes 50. However, a transport box 50 may also contain an object 2 that does not belong or is not intended to belong to a work order 4. In this case, the discharge conveyor 55 optionally serves for intermediate storage, in particular if a later return of this transport box 50 to a handling apparatus 18, 28, 38 for further loading is possible.

Preferably, the discharge conveyor 55 is arranged behind the storage units 10, 20, 30 and/or behind or at the end of the transport tracks 51, 52, 53. Alternatively or additionally, the discharge conveyor 55 is arranged behind the printer 49. This makes it possible to eject transport boxes 50 with incorrectly produced or printed “job tickets”.

The discharge conveyor 55 preferably branches off from or runs parallel to the third transport track 53, which serves to discharge or deliver loaded transport boxes 50.

Optionally, the system 1 has—in particular as an alternative to or in addition to the discharge conveyor 55—an intermediate storage 9 for transport boxes 50, in particular fully loaded, but possibly also partially loaded, as indicated in FIG. 1.

Optionally, the system 1 has—in particular as an alternative to or in addition to the intermediate storage 9—a box storage 8 for empty, but possibly also partially loaded transport boxes 50. In particular, the empty transport boxes 50 can be delivered or output from the box storage 8 to or via the (first) transport track 51.

Expediently, the intermediate storage or storage or holding of transport boxes 50 is carried out in stacks or in the form of stacks, as can be seen in particular in FIGS. 2 and 3.

Optionally, the system 1 has a container storage 7 for empty, but possibly also loaded and/or faulty storage containers 3. The container storage 7 is preferably connected to the return conveyor 54 and/or arranged in the return conveyor upstream of the packing station 40, 41 or the storage container 44, 45.

Preferably, the unpacking of packed objects 2, such as lens blanks packed in cardboard boxes or spectacle frames packed in plastic bags, is carried out after, in particular, the complete picking of objects 2 belonging to a work order 4, i.e. preferably after the transport boxes 50 have been loaded with all objects 2 belonging to the work order 4, in particular after they have left the system 1 or intermediate storage 9.

Unpacking can be performed manually, in particular by an operator, and/or automatically, for example by processing equipment designed to unpack objects 2.

Particularly preferably, a single transport box 50 contains all objects 2 belonging to a particular work order 4, i.e., exactly one work order 4. However, optionally, two or more transport boxes 50 may also contain the objects 2 belonging to a particular work order 4, i.e., exactly one work order 4.

After the transport boxes 50, which in particular are equipped with objects 2 belonging to a work order 4, have been transported out of the system 1, the transport boxes 50 can be transported to a working position or conveyed further to a processing system or device not shown.

The working position or processing equipment may be processing equipment, such as blocking devices, turning and/or milling machines, polishing machines, cleaning machines, coating devices and/or other machines or devices, which are used in particular for manufacturing a pair of spectacles from lens blanks and a spectacle frame.

The transport boxes 50 can also be inserted into a self-organizing system, as described, for example, in EP 2 822 883 A1.

As a result, a system 1, a method and a use are proposed with which any objects 2, in particular those belonging to the same work order 4, can be accommodated, preferably automatically, in one and the same transport box 50, which can be adapted highly flexibly to customer requirements and which have a high degree of redundancy, so that in the event of failure of, for example, a storage device 10, 20, 30, the remaining components of the system 1 according to the proposal can continue to work.

A method according to the proposal is preferably characterized by the following method steps: depositing stored objects 2 on at least one collecting conveyor 16, 26, 36 in such a way that objects 2 belonging to a defined work order 4 are deposited adjacent to one another, transporting the objects 2 deposited on the at least one collecting conveyor 16, 26, 36 to the storage outlet 17, 27, 37, loading a transport box 50 with the deposited objects 2 belonging to a defined work order 4, and transporting the loaded transport box 50 out of the system 1.

Another aspect of the present invention, which can also be implemented independently, preferably provides that storage containers 3 with objects 2 therein are first assembled for a work order 4 and then the objects 2 for the work order 4 are transferred from the storage containers 3 into a transport box 50. Then, preferably, the storage containers 3 are conveyed back and loaded or charged with new objects 2 for storage or temporary storage.

According to the proposal, in particular an automated and optimized picking of objects 2 for the manufacture of eyeglasses is enabled. Here it is to be taken into account that the objects 2 required in each case for the manufacture of a pair of spectacles, in particular lenses or lens blanks, but also a spectacle frame, a tool and/or the like, are deposited in particular in a defined manner or at specific positions in a transport box 50 and/or are automatically retrieved or delivered by means of a storage container 3 or a transport box 50, in order to enable simple automated spectacle manufacture.

With the system 1 according to the proposal or the method according to the proposal, it is possible (in contrast to the state of the art) to store objects 2 to be stored at any desired positions within the storage device 10, 20, 30, but to output stored objects 2 in a targeted manner in such a way that, in particular, objects 2 which belong together, i. e.i.e. objects 2 belonging to the same work order 4, are deposited together, i.e. substantially side by side, on a collecting conveyor 16, 26, 36 in such a way that they appear one after the other at the storage outlet 17, 27, 37 so that one and the same transport box 50 can be loaded with them. In other words, the stored objects 2 are preferably not delivered in the order in which they were ordered or requested, but in order of the respective work order 4.

Such work orders 4 are typically manufacturing or assembly orders, whereby the stored objects 2 belonging to a work order 4 can also be operating materials, tools and other components for the manufacture or assembly of an intermediate product or end product. Optionally, the objects 2, for example tools, can also be used for the production of several spectacles, i.e. for several work orders 4, or can be picked or issued.

A particularly preferred application or use of the system or method according to the proposal relates to the optical industry, in particular the manufacture of spectacles. For this purpose, typically two lens blanks, possibly of different processing stages, an associated spectacle frame and/or one or more block pieces are combined, which belong to the same work order 4, for example for a particularly individually specified pair of spectacles.

List of reference signs

| | |
|---|---|
| 1 | System |
| 2 | Object |
| 2a | Identification |
| 3 | Storage container |
| 3a | Storage medium |
| 4 | Work order |
| 5 | Storage shelf |
| 6 | Handling device |
| 6a | Manipulator |
| 7 | Container storage |
| 8 | Box storage |
| 9 | Intermediate storage |
| 10, 20, 30 | Storage unit |
| 11, 31 | Loading device |
| 12, 32 | Conveyor belt |
| 13, 23, 33 | Storage device |
| 14, 24, 34 | Reading device |
| 15, 25, 35 | Storage conveyor |
| 16, 26, 36 | Collecting conveyor |
| 17, 27, 37 | Storage outlet |
| 18, 28, 38 | Handling apparatus |
| 18a, 28a, 38a | Conveyor section |
| 18b, 28b, 38b | Manipulator |
| 19, 29, 39 | Depositing location |
| 40, 41 | Packing station |
| 42, 43 | Packaging unit |
| 44, 45 | Storage container |
| 46 | Conveyor belt |
| 48 | Reader |
| 49 | Printer |
| 50 | Transport box |
| 50a | Receiving location |
| 51, 52, 53 | Transport track |
| 54 | Return conveyor |
| 55 | Discharge conveyor |
| 56 | Buffer zone |
| 103, 203, 303 | Storage inlet |
| B1-B5 | Area |
| I, II, III, IV | Storage position |

1-41. (canceled)

42. A system configured for transporting and storing objects, comprising:
at least two storage devices comprising storage shelves,
at least one storage inlet,
at least one storage outlet, and
at least one handling device configured to store objects,
wherein each storage device or the storage devices has or have at least one collecting conveyor which extends along the storage shelves and opens into the storage outlet,
wherein at least one transport track for transport boxes extends along the storage outlets,
wherein a handling apparatus is assigned to the storage outlets or is provided at each storage outlet and is suitable for loading a transport box with storable or stored objects located on the respective collecting conveyor or on the collecting conveyors, such that each transport box finally contains objects to be stored or stored which belong to exactly one defined work order, and
wherein the handling device is configured for gripping objects or storage containers with the objects from its respective storage location or from the respective storage shelf and for the defined depositing and/or positioning of objects or storage containers with the objects on the collecting belt.

43. The system according to claim 42, wherein the at least one collecting conveyor is designed and/or controlled so as to transport objects to be stored or stored which belong to a defined work order together to the storage outlet.

44. The system according to claim 42, wherein the at least one collecting conveyor is clock-controlled, and/or wherein at least two transport tracks are provided for transport boxes.

45. The system according to claim 42, wherein at least two transport tracks or the system is or are designed in such a way that transport boxes can change or be pushed between the at least two transport tracks.

46. The system according to claim 42, wherein at least one transport track is designed in such a way that loaded transport boxes can be transported out of the system.

47. The system according to claim 42, wherein a first transport track is provided for feeding empty transport boxes, a second transport track is provided for loading the transport boxes with the objects, and the second or a third transport track is provided for conveying away and/or temporarily storing loaded transport boxes.

48. The system according to claim 42, wherein the at least one transport track or all transport tracks runs or run under the at least one collecting conveyor.

49. The system according to claim 42, wherein collecting conveyors and storage shelves run parallel to one another and the at least one transport track runs transversely or perpendicularly thereto.

50. The system according to claim 42, wherein at least some of the objects to be stored are received or receivable in storage containers.

51. The system according to claim 50, wherein the storage containers are provided with a computer readable storage medium, and/or wherein at least one reader is provided which is suitable for reading a computer readable storage medium on a storage container or a transport box and/or an identification located on the storable object or its packaging, in order to identify the objects or to be able to ensure or check the loading of a transport box desired for the work order.

52. The system according to claim 50, wherein at least one return conveyor for storage containers is provided for returning empty storage containers to a packing station of the system for filling the storage containers with objects to be stored.

53. The system according to claim 42, wherein the handling device is designed for the defined depositing and/or positioning of objects and/or of storage containers with the objects on the respective collecting conveyor.

54. The system according to claim 42, wherein the handling device is designed for retrieving objects or objects accommodated in a storage container from a storage shelf and storing them in the storage shelf.

55. The system according to claim 42, wherein the handling apparatus is designed for picking up the objects from the respective collecting conveyor, deposit location and/or storage container.

56. The system according to claim 42, wherein the handling apparatus is arranged above an associated collecting conveyor and above an associated transport track.

57. A system configured to transport and store objects comprising:
at least two storage devices comprising storage shelves,
at least one storage inlet,
at least one storage outlet, and
at least one handling device configured to store objects,
wherein each storage device or the storage devices has or have at least one collecting conveyor which extends along the storage shelves and opens into the storage outlet,
wherein at least one transport track for transport boxes extends along the storage outlets,
wherein a handling apparatus is assigned to the storage outlets or is provided at each storage outlet and is configured for loading a transport box with storable or stored objects located on the respective collecting conveyor or on the collecting conveyors, such that each transport box finally contains objects to be stored or stored which belong to exactly one defined work order, and
wherein a first transport track is provided for feeding empty transport boxes, a second transport track is provided for loading the transport boxes with the objects, and the second or a third transport track is provided for conveying away and/or temporarily storing loaded transport boxes.

58. The system according to claim 57, wherein the handling apparatus is designed for individually picking up the objects from the respective collecting conveyor, deposit location and/or storage container and for depositing them in a defined manner and/or individually in the transport box.

59. The system according to claim 58, wherein the handling device is suitable for gripping objects or storage containers with the objects from its respective storage location or from the respective storage shelf and for the defined depositing and/or positioning of objects or storage containers with the objects on the collecting belt.

60. A system configured for transporting and storing objects comprising:
at least two storage devices comprising storage shelves,
at least one storage inlet,
at least one storage outlet, and
at least one handling device configured to store objects,
wherein each storage device or the storage devices has or have at least one collecting conveyor which extends along the storage shelves and opens into the storage outlet, wherein at least one transport track for transport boxes extends along the storage outlets,
wherein a handling apparatus is assigned to the storage outlets or is provided at each storage outlet and is configured for loading a transport box with storable or stored objects located on the respective collecting conveyor or on the collecting conveyors, such that each transport box finally contains objects to be stored or stored which belong to exactly one defined work order, and
wherein the handling apparatus is designed for individually picking up the objects from the respective collecting conveyor, deposit location and/or storage container and for depositing them in a defined manner and/or individually in the transport box.

61. The system according to claim 60, wherein the system or the handling apparatus is designed for individually transferring, changing and/or pushing the transport boxes from one transport track to another.
